(19) United States
(12) Patent Application Publication
(10) Pub. No.: US 2007/0199236 A1
(43) Pub. Date: Aug. 30, 2007

(54) Chum chucker, a chum distributing device

(76) Inventor: Frank T. Brzozowski, Philadelphia, PA (US)

Correspondence Address: FRANK T. BRZOZOWSKI, 2357 E. Dauphin Street, Philadelphia, PA, 19125, US

(21) Appl. No.: 11/712,662

(22) Filed: Feb. 28, 2007

Related U.S. Application Data
(60) Provisional application No. 60/777,489, filed on Feb. 28, 2006.

(51) Int. Cl. A01K 97/02

(52) U.S. Cl. 43/44.99

(57) ABSTRACT

A chum chucker is a chum distributing device 30. It has a proximal end 70 yielding a gripping sleeve 72 and a lengthwise shaft 78, including a telescopic handle 78 that has a length of handle on the distal end 80 that serves as a rear support 34, thus becoming a connecting means of fixedly joining lengthwise by a rear collar 32 of an upright scoop container 40 to yield maximum strength and support that a scoop component 50 has while joined by a scoop 52 a chum chamber 42, and while being braced against the said area of distal shaft 80. The distal shaft 80 in this embodiment has multipurpose functions 69 such as different shaped scoops 50 and attachments including fish net 98 and gaff.

### CROSS REFERENCE TO RELATED APPLICATIONS

U.S. Patent Documents

| Country-Number | MM-YYYY | Name | Classification |
|---|---|---|---|
| US-6,962,541 | November 2005 | Mitzak, K. | 473/513 |
| US-6,949,037 | September 2005 | Enos, R and | 473/553 |
| | | Huling, R. | |
| US-6,076,829 | June 2000 | Oblack, M. | 473/415-541 |
| US-6,066,056 | May 2000 | Morrow, D. | 473/513 |
| US-5,967,912 | October 1999 | Hexemer, M. | 473/513 |
| US-3,656,252 | April 1972 | Sherman, S. | 43/19, 124/21 |
| US-3,589,349 | June 1971 | Parker, R. | 124/5-9 41.30 |
| US-3,494,061 | June 1967 | Pool, S. | 43/19 |

### OTHER REFERENCES

Knapp, Jeff “early Summer Carp Tactics,” Pennsylvania Angular and Boater, pp. 22-23, www.fish.state.pa.us, May-June 2005.

Peek Ken, and Labiste Dino. “Clay Thrower Made from Bamboo,” downloaded http://www.primitiveways.com/bamboo_clay_thrower.html, 19 Feb. 2007.

### PARENT CASE TEXT AND RELATED APPLICATIONS

This application, for a utility patent for a “chum chucker, a chum distributing device” incorporates, and is based on the provisional application No. US60/777,489 filed on Feb. 28, 2006.

### BACKGROUND OF THE INVENTION

The present invention relates to the field of long handled throwing implements in general and in particular to a long handled chum distributing device having a novel chum receptacle formed on its distal end. The prior art is replete with myriad and diverse long hand throwing implements and bait casting arrangements.

While all of the aforementioned prior art constructions are more than adequate for the basic purpose and function for which they have been specifically designed, they are uniformly deficient with respect to their failure to provide a simple, efficient, and a practical long handled implement for distributing chum and other forms of fish baits including but not limited to corn, dough balls, fish pellets and/or processed foods.

Hatchery trout become accustomed to eating pellets. Casting from a bank on a fresh water lake a pound of corn or chopped meat scattered into deeper water draws fish to the area. Conversely, as most fishermen are aware, the effective use of chum or chopped fish bait in salt water is noticeably enhanced by the ability to disperse the chum over a wide surface area of a body of water so that the chum slick will attract a greater number of fish.

Unfortunately, at the present time, a device does not exist that can either perform that basic desired function, or can produce a unique dispersion of the chum or other types of bait. As a consequence of the foregoing situation, there has existed a longstanding need among fishermen for a new and improved chum distributing device that employs a long handle for leverage and a novel open mouthed enlarged capacity chambered container with a scoop, to propel the chum substantial distances and over a wide surface area; and the provision of such a construction is a stated objective of the present invention.

1. Field of the Invention

The present invention relates to the field of long handled throwing implements in general and in particular to a long handled chum distributing device having a novel chum receptacle formed on its distal end.

2. Description of Related Art

The present invention relates to the field of long handled throwing implements in general and in particular to a long handled chum distributing device having a novel chum receptacle formed on its distal end.

Prototype and personal drawings were examined by William H. Wright, Reg. 26,424 who released a favorable opinion after his study of the Field of Search 273/317, 43/19 124/51 and reviewing the references cited: U.S. Pat. Nos. 3,494,061, 6,076,829, 3,656,252, and 3,589,349. In Mr. Wrights opinion with reference to the said patents cited “the prior art is replete with myriad and diverse long handled throwing implements and bait casting arrangements.”

A casting rod by Sherman, U.S. Pat. No. 3,656,252, exhibits a fishing rod and reel connected to a spring launcher that ejects bait attached to fishing line. Sherman's invention is different from the chum chucker whose fishing pole prototype had the fishing reel and the eyelets removed and the bait is ejected manually by a casting motion.

U.S. Pat. No. 3,494,061 was issued to Pool for a bait casting apparatus which seems like a spring mechanism hand held device to shoot bait attached to a fishing line through a tube. Pool's patent is closer to a clay thrower than this invention. An article Ken Peek and Dino Labiste “Clay Thrower Made from Bamboo,” demonstrated the ancient weapon of hurling clay and rocks from a hand-held bamboo apparatus with a long shut that was used to chase animals from their crops. The clay thrower and Pool's bait casting apparatus has no resemblance to the embodiments in this application.

A ball-gripping and throwing apparatus by Parker, U.S. Pat. No. 3,589,349, exhibits a small mechanical device made to throw balls and would not be effective in hurling bait and chum. Oblack invented a ball throwing apparatus and method, U.S. Pat. No. 6,076,829. Both Oblack's and Parker's inventions are for throwing balls and are not constructed to cast bait; both inventions are closer to another than the chum chucker.

Internet searches of lacrosse sticks revealed sporting equipment that had strict standards as to their size and shape, none of them resembled the chum chucker, a chum distributing device. Although a chum chucker could possible resemble the lacrosse stick the embodiments in this invention have many differences, the laces of the netting of the lacrosse stick differ, and the back of the lacrosse stick is totally opened and would not be effective in hurling small pieces of chum and fish bait. The net in the preferred embodiment FIGS. 1-6 is a fishnet that would not be effective in the sport of lacrosse. Many lacrosse patents exist that are much closer to their field of study than the present invention. Hexemer patent, U.S. Pat. No. 5,967,912 for lacelock for a lacrosse stick head. Morrow was issued a patent U.S. Pat. No. 6,066,056 for a lacrosse head. Enos received a patent for a quick-release fastener for releasably attaching lacrosse stick head to shaft, U.S. Pat. No. 6,949,037. An apparatus for a lacrosse stick head was issued to Mitzak, U.S. Pat. No. 6,962,541. All of the lacrosse patents are much more germane and seem to be very close in structure in comparison to the chum chucker, a chum distributing device.

### BRIEF SUMMARY OF THE INVENTION

The “Chum Chucker” evolved from a sawed-off broken fishing rod with eyelets removed and a plastic cylinder taped to the distal end of a converted fishing rod that was used to propel corn into fresh water. Briefly stated, the chum distributing device that forms the basis of the present invention comprises in general a handle unit and a scoop container means formed on the outboard end of the handle unit.

The preferred embodiment employs a handle unit that includes a telescoping handle member having a proximal end and a distal end that is connectedly joined to a scoop container. The scoop container means includes an enlarged scoop member having a contoured chum receiving chamber that is in open communication with a main chum dispensing chamber which is further surrounded by a contoured peripheral flange which terminates in an upwardly curved outer lip that tends to focus the dispersion of the particles such as chum exits from the chum dispensing chamber.

As can be seen by reference to the drawings, and in particularly to FIG. 1, the chum distributing device that forms the basis of the present invention is designated generally. The chum distributing device comprises in general a handle unit and a scoop container means. These units will now be described in the following.

Of the preferred embodiment depicted in FIGS. 1 and 2, the handle unit comprises an elongated telescoping handle member having a proximal end provided with a resilient gripping sleeve and a hollow internally threaded distal end the purpose and function of which will be described in greater detail further on in the specification.

As can best be seen by reference to FIGS. 2 through 5, an enlarged contoured scoop member having a proximal end provided with external threads that are adapted to threadedly engage the internally threaded distal end of the handle member in a well recognized manner. In addition, as can best be appreciated by reference to FIGS. 3 through 5, the scoop member is further provided with an enlarged intermediate cylindrical portion the hollow interior of which defines a chum receiving chamber the purpose and function of which will be described in greater detail further on in the specification. Still referring to FIGS. 3 through 5, it can be seen that scoop member has an enlarged distal end that includes a generally semi-spherical main chum dispensing chamber the opening of which is surrounded by a contoured peripheral flange which terminates in an upwardly curved outer lip.

Another use includes a handle unit that has a handle shaft having a proximal end and threaded or collared distal end that has multifunction uses by connecting to accessories including a fish net and gaff; and a scoop container unit consisting of independent components that could be replaced with different multifunction parts including a scoop element that has an end means for an outer scoop edge, connected to a large receiving area that allows substances including bait and chum to enter a mouth of a hollow elongated chamber for temporary storage before a cast; and a scoop container unit fixedly joined by a connecting component attaching means to a distal handle shaft area.

In use, a fisherman would deposit a quantity of chum into the hollow interior chamber of the intermediate cylindrical portion of the scoop member and then extend the telescoping handle member to its desired length. Then when the fisherman forcefully swings the handle member in an arc, the chum will be propelled by centrifugal force into the main chum dispensing chamber. Whereupon, as the fisherman swings overhead, the arc of the handle and the force created at the extended attached scoop member, the captive effects of centrifugal force will expel chum from the main chum dispensing chamber. Although only an exemplary embodiment of the invention has been described in detail above; those skilled in the art will readily appreciate that many modifications are possible without materially departing from the novel teachings and advantages of this invention.

There has thus been outlined, rather broadly, the more important features of the embodiment of the invention in order that the detailed description thereof that follows may be better understood and in order that the present contribution to the art may be better appreciated. There are, of course, additional features of the present embodiment of the invention that will be described hereinafter and which will form the subject matter of the claims attached. Other embodiments consist of solid handles, metallic handles, multi-function handles, different scoops with side mounts, with male connectors, with female attachments, and various shaped scoops to produce different patterns of dispersion. The last embodiment consists of a continuous one piece unit.

### BRIEF DESCRIPTION OF THE SEVERAL VIEWS OF THE DRAWINGS

The embodiments of the invention will be better understood and objects other than those set forth above will become apparent when consideration is given to the following detailed description thereof. Such description makes reference to the annexed drawings wherein:

FIG. 1 is a perspective view of a multipurpose chum distributing device;

FIG. 2 is a perspective view of a handle unit in its collapsed mode;

FIG. 3 is an exploded perspective view showing an alternate net attachment for the handle unit;

FIG. 4 is an exploded perspective view of a scoop unit with a rear connector;

FIG. 5 is a side elevation view of the scoop head;

FIG. 6 is an isolated perspective view of a telescopic handle and a circular scoop unit;

FIG. 7 is an enlarged perspective view of a circular scoop unit;

FIG. 8 is an enlarged top view of an egged scoop unit;

FIG. 9 is an enlarged partly cut away chamber with side view of an egged scoop unit;

FIG. 10 is an isolated perspective view of a version of a partitioned scoop unit;

FIG. 11 is a perspective view of a partitioned scoop unit employed on a fully extended handle unit;

FIG. 12 is a perspective view of the a handle unit and a partitioned scoop unit in the collapsed mode;

FIG. 13 is a partial cross-sectional view showing a portion of the interim of a partitioned scoop unit.

FIG. 14 is a side view of a partitioned scoop unit employed on an alternate fully extended handle;

FIG. 15 is an enlarged cross-sectional view showing a female collar of a partitioned scoop unit and a splice to a tubular handle.

FIG. 16 is a perspective view of a partitioned scoop unit employed on an alternate extended handle;

FIG. 17 is a side view of a spade scoop unit employed on an alternate long handle;

FIG. 18 is an enlarged partial cross-sectional view showing a male member of a scoop unit inserted in a female collar of a shaft of a handle;

FIG. 19 is a perspective view of a male scoop unit employed on an alternate long handle;

FIG. 20 is a partial cross-sectional view showing a flat wide mouth scoop unit with a long handle;

FIG. 21 is a side view showing a male member of a flat wide mouth scoop unit with a long handle;

FIG. 22 is an enlarged partial cross-sectional view showing a male member of a scoop unit inserted over a male connector of a shaft of a handle;

FIG. 23 is a perspective view of a male flat wide mouth scoop unit employed on an alternate long handle;

FIG. 24 is a partial cross-sectional view showing a slanted flat mouth scoop unit with a long handle;

FIG. 25 is a side view showing a female member of a slanted flat mouth scoop unit with a long handle;

FIG. 26 is an enlarged partial cross-sectional view showing a female member of a slanted flat mouth scoop unit inserted over a male connector of a shaft of a handle;

FIG. 27 is a perspective view of a female slanted flat mouth scoop unit employed on an alternate long handle;

FIG. 28 is a side view of a deep scoop unit employed on an alternate short handle; and

FIG. 29 is a front view of a deep scoop unit employed on an alternate short handle.

### DETAILED DESCRIPTION OF THE INVENTION

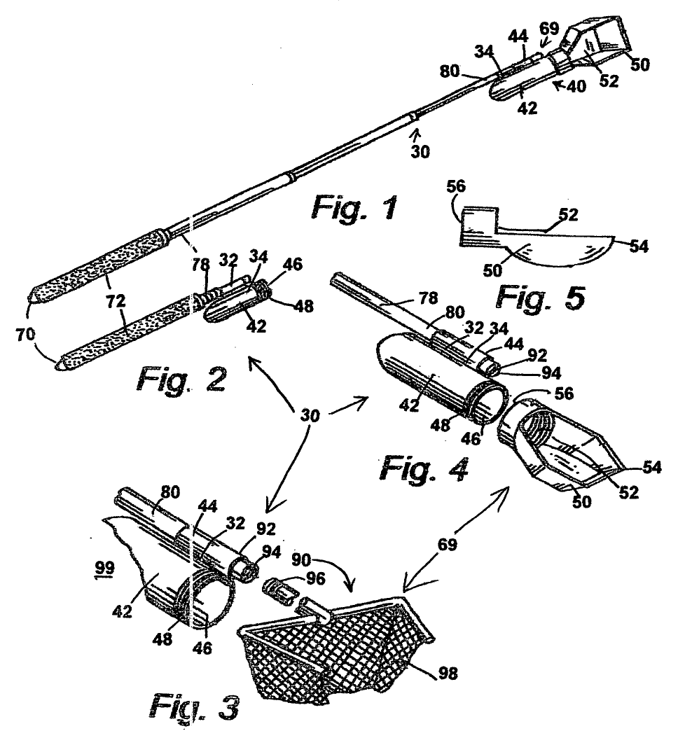

A chum chucker, a chum distributing device, is an invention illustrated in FIGS. 1 through 29 with a preferred embodiment exemplified in FIG. 1, reference numeral 30.

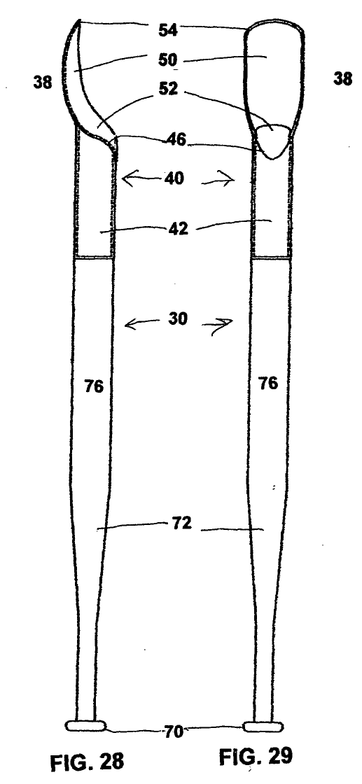

FIGS. 1 through 29 illustrate various embodiments of said invention, with FIGS. 1-5 being the most complex structure through to FIGS. 28-29 being the simplest in construction.

A preferred embodiment is illustrated in FIGS. 1-5. Said chum chucker, a chum distributing device 30 comprises in general a handle unit 72, a scoop container unit 40 and a connecting component 32 as a means of connecting said two units 72, 40 together as, in this embodiment, by a hollow cylindrical collar 44 being a rear attachment 34.

As can be seen by reference to the drawings, and in particularly to FIG. 1, a chum chucker, a chum distributing device that forms the basis of the present invention is designated generally by the reference number 30. It has a proximal end 70 yielding a gripping sleeve 72 and a lengthwise shaft 78 that has a length of handle on the distal end 80 that serves as a rear support 34, thus becoming a connecting means of fixedly joining lengthwise by a rear collar 32 of an upright scoop container 40 to yield maximum strength and support that a scoop component 50 has while joined by a scoop 52 a chum chamber 42, and while being braced against the said area of distal shaft 80. The distal shaft 80 in this embodiment has multipurpose functions 69. These units will now be described in seriatim fashion.

In the first version of the preferred embodiment depicted in FIGS. 1 through 5, a handle unit 72 comprises an elongated telescoping handle member 78 having a proximal end 70 provided with a resilient gripping sleeve 74 and a hollow distal end 92 provided with internal threads 94, the purpose and function of which will be described in greater detail further on in the specification. FIG. 2 is a perspective view of a handle unit in its collapsed mode.

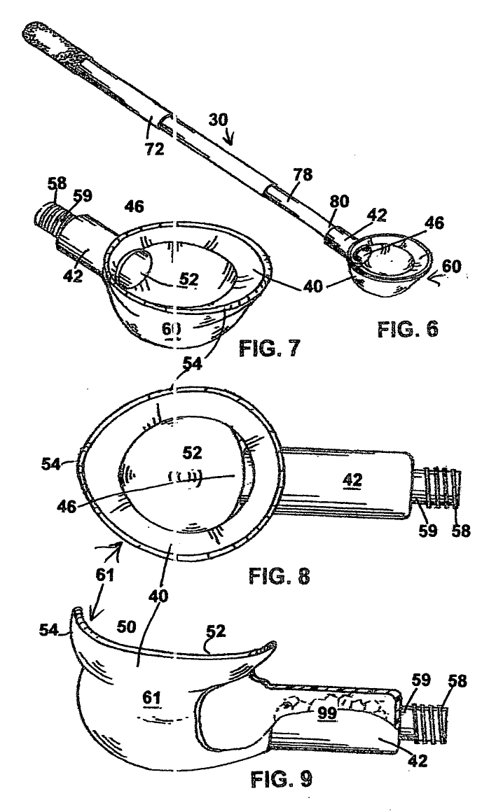

As can best be seen by reference to FIGS. 1 through 5, in the first version of the preferred embodiment, a scoop container unit 40 comprises a two-piece scoop element 50 including a reservoir element 42 having an offset hollow cylindrical collar 44 that is fixedly connected to the handle member 78 proximate a outboard or distal end 92 thereof; wherein a mouth 46 of a reservoir element 42 is externally threaded as at 48. As in FIG. 5 different shaped scoops 50 could be made with the internally threaded bottom 56 that could be screwed unto the external threads 48 of a reservoir chamber 42 that holds chum 99. (The scoops in FIG. 6 to FIG. 29 demonstrate different shapes.)

In addition, in FIG. 4 a scoop member 40 further comprises a scoop element 50 having an enlarged scoop mouth 52 formed on its outboard end 54 and an internally threaded collar 56 formed on its inboard end; wherein, the internally threaded collar 56 is adapted to be releasably connected to the externally threaded mouth 48 of a reservoir element 42.

Turning now to FIG. 3, it can be seen that in the first version of the preferred embodiment, a outboard or distal end 92 is adapted to threadedly receive the threaded stem 96 of a variety of fishing related accessories 90 such as a fishing net 98 or gaff (not shown) to expand the usefulness of a multipurpose chum distributing device 30. FIGS. 6 through 9 are alternate chum distributing devices 30 having a telescopic handle unit 78. FIG. 6 is an isolated perspective view of a telescopic handle 78 and a circular scoop unit 60 and FIG. 7 is an enlarged perspective view of a circular scoop unit 60. FIG. 8 is an enlarged top view of an egged scoop unit 61 with FIG. 9 having an enlarged partly cut away chamber 42 exposing chum 99 with side view of an egged scoop unit 61.

As can best be seen by reference to FIGS. 6 through 9, a scoop container 40 is now a one piece circular unit 60, FIGS. 6 and 7, and in FIGS. 8 and 9 a one piece egg-shape scoop 61 as compared to the previous embodiment. An enlarged contoured scoop member 40 having a bottom male end 59 provided with external threads 58 that are adapted to threadedly engage the internally threaded distal end 80 of the handle member 72 in a well recognized manner. Bait or chum would be received in a circular scoop 60 by a scoop mouth 52 and held in a chum chamber 42.

In addition, as can best be appreciated by reference to FIGS. 7 through 9, a egg-shaped scoop container member 61 is further provided with an enlarged intermediate cylindrical portion 42 a hollow interior of which defines a chum receiving chamber 46 the purpose and function of which will be described in greater detail further on in the specification. Still referring to FIGS. 6 through 9, it can be seen that scoop member 40 has an enlarged distal end 54 that includes a generally semi-spherical main chum dispensing chamber 52 the opening of which is surrounded by a contoured peripheral flange 54 which terminates in an upwardly curved egg-shaped edge 61.

In use, a fisherman extend a telescoping handle member 78 to its desired length and then deposit a quantity of chum or bait into a hollow interior chamber 46 of the intermediate cylindrical portion 42 of said scoop member 40. Then when the fisherman swings the handle member 72 in an arc, the chum 99 will be propelled by centrifugal force into the main chum dispensing chamber 52, whereupon, as the fisherman slows the arc of the handle 72 and attached scoop member 40, the captive effects of centrifugal force will allow the chum to exit from the main chum dispensing chamber 52.

At this juncture, the outwardly projecting peripheral flange 54 with its upwardly curved egg-shaped edge 61 to recapture slower moving particles of chum to redirect those particles along the desired path of travel of the main body of chum particles onto the fisherman and his surroundings such as a fishing boat or the like. In closing, it should further be noted that the hollow cylindrical intermediate portion 42 of the scoop member 40 is axially aligned with the longitudinal axis of the hollow cylindrical intermediate portion 42 that is disposed proximate to but spaced from a peripheral flange 54 of a scoop member 40.

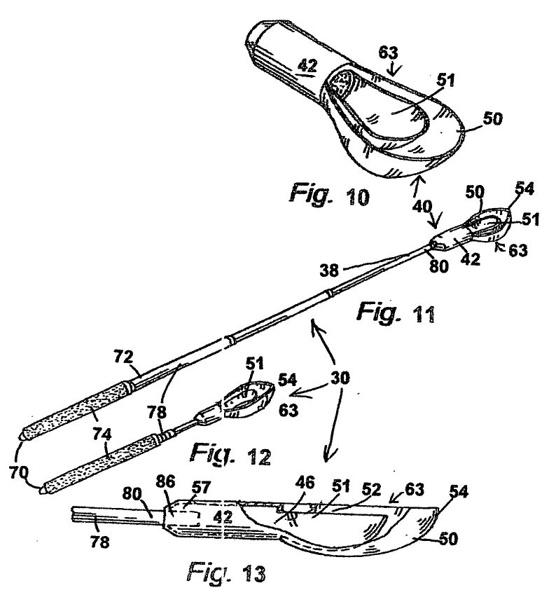

In the alternate version of the preferred embodiment a partitioned scoop unit 63 depicted in FIGS. 10 through 13, it can be seen that the chum distribution device 30 employs a telescopic handle unit 72 virtually identical to the handle unit 72 previously described herein with a gripping sleeve 74 on a proximate end 70, but at the distal end 38 a scoop unit 40 has two partitions 50 and 51 to receive chum or bait in the chum chamber 42. In fact, the primary difference between the primary device 30 and alternate versions of the invention FIG. 7 to FIG. 29 involves the partitioned scoop unit 63 to the scoop container units 40 of the alternate versions 30. To Wit: FIG. 10 is an isolated perspective view of a version of a partitioned scoop unit 63. FIG. 11 is a perspective view of a partitioned scoop unit 63 employed on a fully extended handle unit 72. FIG. 12 is a perspective view of the a handle unit 72 and a partitioned scoop unit 63 in the collapsed mode. FIG. 13 is a partial cross-sectional view showing a portion of the interim of a partitioned scoop unit 63.

This scoop unit 40 can best be appreciated by reference to FIGS. 10 and 13, and comprises a one-piece scoop member 40 having a reservoir element 42 the inboard end of which is operatively secured to an outboard or distal end 38 of a handle member 78 wherein, a mouth 46 of a reservoir element 42 is in direct communication with an inner scoop element 51 which is surrounded by an outer scoop element 50.

As can be appreciated by reference to FIGS. 10 and 13, when a scoop unit 40 is inserted into a chum bucket or other container, the majority of heavier chum will wind up inside the reservoir element 42 and inner scoop element 51 with a lesser quantity that floats being contained within the outer scoop element 50.

As a consequence of the foregoing situation, a much different chum pattern is distributed from an alternate scoop unit 40 due to the fact that the lesser quantity of chum in a outer scoop element 50 will have the opportunity to travel further than the greater volume of chum in a reservoir element 42 and in a inner scoop element 51 based on well accepted physical principles and dynamics.

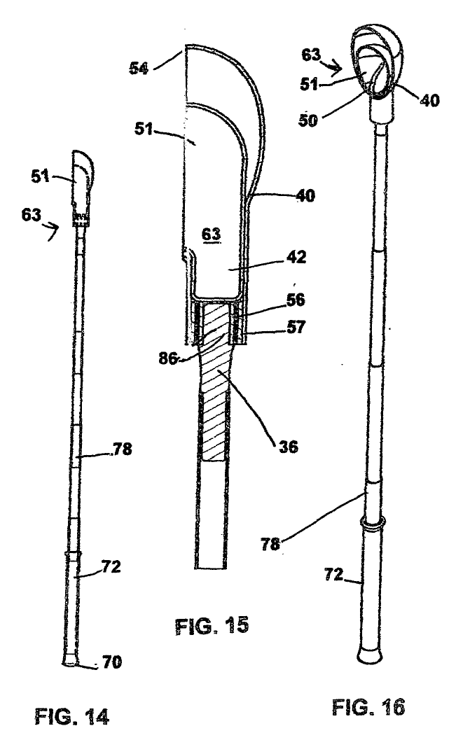

Embodiments in FIG. 14 to 16 are chum distributing devices with a partitioned scoop 63 attached to a fully extended bare telescopic handle unit 72 that is mounted upon an male distal end 86 of a telescopic shaft 78. A female member collar 57 has internal threads 56 at the base the scoop container unit 40. A partitioned scoop element 63 is attached to a telescopic handle 78 by a splice 36 that is inserted in a distal end 80 of said shaft 78. FIG. 14 is a side view of a partitioned scoop unit employed on an alternate fully extended handle. FIG. 15 is an enlarged cross-sectional view showing a female collar of a partitioned scoop unit and a splice to a tubular handle. FIG. 16 is a perspective view of a partitioned scoop unit employed on an alternate extended handle.

In FIG. 1 through FIG. 29 a subset feature of the scoop unit 40 is various connecting components 32 that are the means of attaching to the handle unit 72. Connecting components are rear attachments 34, female ends 58 and male ends 59 that allow different types of handle units 72 to be utilized in the invention 30.

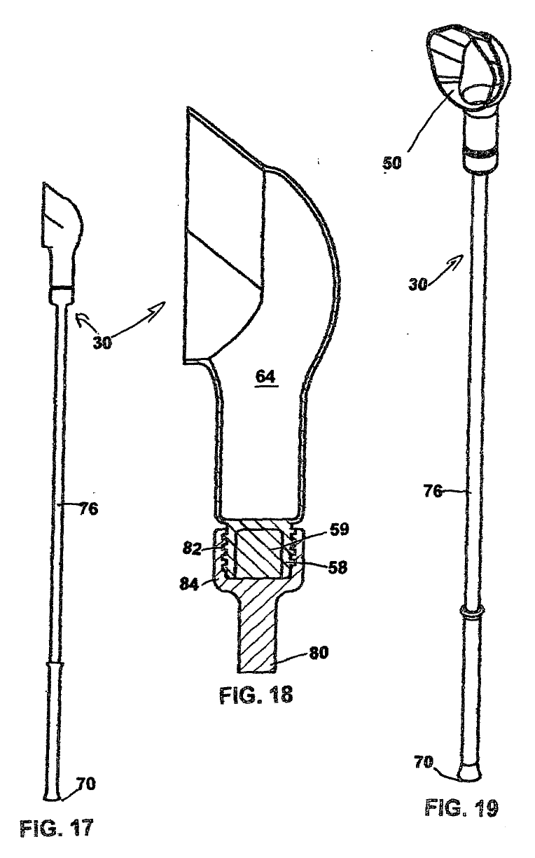

FIGS. 17-19 illustrate a chum distributing device 30 with a bare long handle 76 at the proximate end 70 and at the distal end 80 a female collar 84 supporting a spade shaped scoop container 64. FIG. 17 is a side view of a spade scoop unit 64 employed on an alternate long handle 76 and FIG. 19 is a perspective view of a male scoop unit 59 employed on an alternate long handle 76. A shaft 76 has a threaded distal end 82 that accepts the male end base 59 of the scoop element 50. The scoop element 50 has a threaded male member 58 that is screwed into the distal end of the shaft 84 designated by FIG. 18 showing an enlarged partial cross-sectional view showing a male member 59 of a scoop unit 50 inserted in a female collar 84 of a shaft of a handle 80.

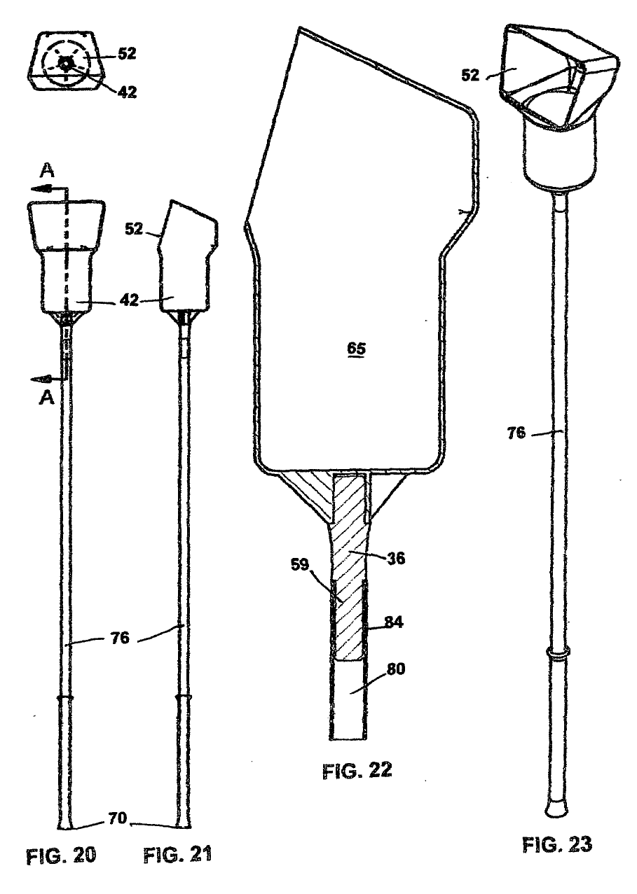

Another embodiment of the chum chucker, chum distributing device 30 is illustrated in FIGS. 20-23 that show a flat wide mouth scoop unit 65 with a long handle 76. FIG. 22 is an enlarged partial cross-sectional view showing a male member of a scoop unit 59 inserted into a tubular female connector 84 of a distal end 80 shaft of a handle 76. A splice 36 is originally solidly joined into the female base end 58 of the scoop container 42 yielding a protrusion 59 that is inserted into the tubular handle 76. FIGS. 20, 21 and 23 show different rotations of the device 30 depicting a female flat wide mouth scoop unit 65 employed on an alternate long handle 76. FIG. 20 has a cross section view that shows the flat wide mouth scoop 52 with the reservoir 42.

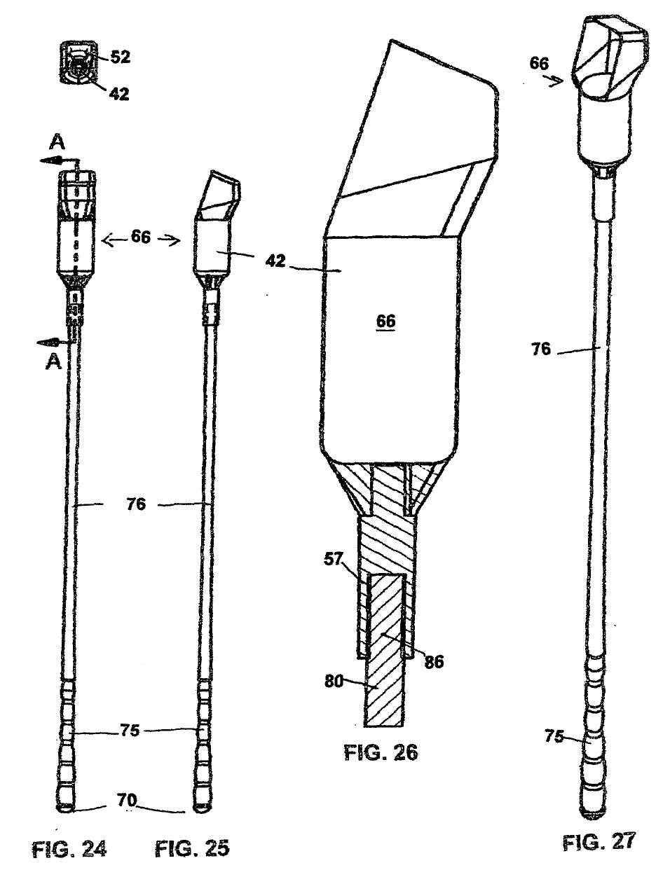

FIGS. 24-27 is a embodiment of the chum distributing device 30 that has a tilted flat mouth scoop 66 that is secured upon an alternate long handle 75, which has finger grips 75 at the proximal end 70. In FIG. 26 at the bottom of the chum receptacle 42 a female collar 57 has been solidly spliced to the tilted flat mouth scoop 66. A male member of the shaft 86 at the distal end 80 of the handle 76 is inserted into the base of the scoop container 42. FIG. 24 shows a partial cross-sectional view showing a slanted flat mouth scoop unit 66 with a long handle 76 with a cross section identifying the reservoir 42 in relation to the tilted flat mouth scoop 66.

Another chum chucker, a chum distributing device 30 FIGS. 28-29, is a one piece unit 68 with a short handle 76 that has areas of the embodiments correlating to the main components in the preceding embodiments FIGS. 1-27. This small chum distributing device could be easily used by children. It consists of a proximal end 70 followed by a shaft 76 that abuts a reservoir 42 of a chum receptacle 40. At a distal end 38 a scoop blade 50 connects to a scoop mouth 46 that partly encircles a chum chamber 42. A scoop blade 50 is slightly curved resembling a large spoon.

Numerous objects, features and advantages of the present embodiment of the invention will be readily apparent to those of ordinary skill in the art when taken in conjunction with the accompanying drawings. Upon a reading of the following detailed description of presently preferred but nonetheless illustrative, embodiments of the present embodiment of the invention, unique differences have been established in contrast to prior art. In this respect, before explaining the current embodiment of the embodiment of the invention in detail, it is to be understood that the embodiment of the invention is not limited in its application to the details of construction and to the drawings. For example, a chum chucker, a chum distributing device, could be constructed with variations from a continuous one piece unit that is small, hollow and light for children, or with a longer larger chum receptacle with a solid shaft could be used in rugged conditions. The invention could also have many types of handles including but not limited to fiberglass, wood, plastic, graphite, bamboo, metal, tubular, flexible memory, and rubber components. In the drawings the chamber of the scoop container is round and cylindered; however, different geometric shapes could have been made including but not limited to hexagon, triangular, semi-circular, grooved and banana-shape. The scoop attachments, in the drawings, are predominately curved but they could be made of various sizes including but not limited to various thickness, lengths, with straight edges, and shapes resembling spoons, shovels and deflectors. The chum receptacle could have a modified chamber or chambers to propel different substances including but not limited to cooked rice, beans, seeds, chopped fruit, fish parts, eggs, squid, clam, slugs, snails, bait fish, fish byproducts, fowl, animal components, meat byproducts, worms, larva, insects, candy, cereal, dough balls, flavored pasta, food pellets, dog food, dried blood, calcium components, vitamins, salted meat and large salt particles.

The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is this important, therefore, that the claims be regarded as including such equivalent constructions insofar as they do not depart from the spirit and scope of the present embodiment of the invention.

Therefore, the foregoing is considered as illustrative only of the principles of the embodiment of the invention. Further, since numerous modifications and changes will readily occur to those skilled in the art, it is not desired to limit the embodiment of the invention to the exact construction and operation shown and described, and accordingly, all suitable modifications and equivalents may be resorted to falling within the scope of the embodiment of the invention.

What I claim as new is as follows:

1. A chum chucker, a chum distributing device comprising
a handle unit including a handle shaft having a proximal end and threaded or collared distal end;
a scoop container unit including an enlonged scoop element that has an end means for an outer scoop edge, connected to a large receiving area that allows substances including bait and chum to enter a mouth of a hollow elongated chamber for temporary storage before a cast; and
a scoop container unit fixedly joined by a connecting component attaching means to a distal handle shaft area.

2. A chum chucker, a chum distributing device comprising
a handle unit including a handle shaft having a proximal end and threaded or collared distal end that has multifunction uses by connecting to accessories including a fish net and gaff;
a scoop container unit consisting of independent components that could be replaced with different multifunction parts including a scoop element that has an end means for an outer scoop edge, connected to a large receiving area that allows substances including bait and chum to enter a mouth of a hollow elongated chamber for temporary storage before a cast; and
a scoop container unit fixedly joined by a connecting component attaching means to a distal handle shaft area.

3. A chum chucker, a chum distributing device comprising
a one piece unit with a short handle that has areas of the embodiments correlating to a proximal end followed by a shaft that abuts the reservoir of a enlonged chum receptacle; and
a distal end has a scoop blade resembling a elongated spoon connecting to a scoop mouth that partly encircles the chum chamber.

4. In combination the device in claim 1 wherein
a handle, shaft and scoop unit is made of various materials including but not limited to fiberglass, wood, plastic, graphite, bamboo, metal, tubular, flexible memory, and rubber components; and
a scoop container unit is made of various shapes including round, cylindered, geometric shapes including hexagon, triangular, semi-circular, grooved, banana-shape, straight edges, and shapes resembling spoons, shovels and deflectors.

5. In combination the device in claim 2 wherein
a handle, shaft and scoop unit is made of various materials including but not limited to fiberglass, wood, plastic, graphite, bamboo, metal, tubular, flexible memory, and rubber components; and
a scoop container unit is made of various shapes including round, cylindered, geometric shapes including hexagon, triangular, semi-circular, grooved, banana-shape, straight edges, and shapes resembling spoons, shovels and deflectors.

6. In combination the device in claim 3 wherein
a handle, shaft and scoop unit is made of various materials including but not limited to fiberglass, wood, plastic, graphite, bamboo, metal, tubular, flexible memory, and rubber components; and
a scoop container unit is made of various shapes including round, cylindered, geometric shapes including hexagon, triangular, semi-circular, grooved, banana-shape, straight edges, and shapes resembling spoons, shovels and deflectors.

7. The chum distributing device of claim 1 wherein the connecting components a) are male members;
b) are female members; and
c) are rear connecting members.

8. The chum distributing device of claim 2 wherein the connecting components a)
are male members;
b) are female members; and
c) are rear connecting members.

9. The chum distributing device of claim 1 wherein the handle
a) has a gripping sleeve
b) has finger grooves, and
c) is bare and straight.

10. The chum distributing device of claim 2 wherein the handle
a) has a gripping sleeve
b) has finger grooves, and
c) is bare and straight.

11. The chum distributing device of claim 3 wherein the handle
a) has a gripping sleeve
b) has finger grooves, and
c) is bare and straight.

12. The chum distributing device of claim 1 wherein the scoop unit has a partitioned scoop container unit.

13. The chum distributing device of claim 1 wherein the scoop member is axially aligned with a handle member.

14. The chum distributing device of claim 2 wherein the scoop member is offset and in front of a handle member.

15. The chum distributing device of claim 1 wherein the scoop member is offset and in front of a handle member.

16. The chum distributing device of claim 1 wherein handle unit is spliced with a connecting attachment to the scoop container unit.

17. The chum distributing device of claim 2 wherein handle unit is spliced with a connecting attachment to the scoop container unit.

18. The chum distributing device of claim 2 wherein a chum chamber has threads at its mouth to connect attachments.

19. The chum distributing device of claim wherein the scoop container unit has a wide mouth with flat areas.
